(19) United States
(12) Patent Application Publication
(10) Pub. No.: US 2026/0269922 A1
(43) Pub. Date: Sep. 10, 2026

(54) SYSTEMS AND METHODS FOR REDUCING MEASUREMENT DELAY FOR GROUP-BASED BEAM REPORTING

(71) Applicant: APPLE INC., Cupertino, CA (US)

(72) Inventors: Xiang Chen, Campbell, CA (US); Yang Tang, San Jose, CA (US); Jie Cui, San Jose, CA (US); Dawei Zhang, Saratoga, CA (US); Haitong Sun, Cupertino, CA (US); Manasa Raghavan, Sunnyvale, CA (US); Konstantinos Sarrigeorgidis, Los Gatos, CA (US)

(21) Appl. No.: 19/167,954

(22) PCT Filed: May 8, 2024
(86) PCT No.: PCT/US2024/028308

§ 371 Date: Sep. 23, 2025

Related U.S. Application Data
(60) Provisional application No. 63/501,443, filed on May 11, 2023.

(51) Int. Cl. H04B 7/06; H04L 5/00; H04W 72/231; H04W 72/542

(52) U.S. Cl. CPC H04B 7/06956; H04L 5/0094; H04W 72/231; H04W 72/542

(57) ABSTRACT

Systems and methods for reducing measurement delay for group-based beam reporting (GBBR) are disclosed herein. A user equipment (UE) having first and a second antenna panels receives, from a network, a pair of channel measurement resource (CMR) sets identifying reference signals transmitted across a pair of transmission reception points (TRPs) and that are together transmitted periodically. The UE measures the reference signals using narrow beams within a plurality of broader beams that each correspond to one of the reference signals and that is on one of the antenna panels and selects first and second narrow beams (one on each antenna panel) to use for simultaneous downlink (DL) reception. The UE sends a beam report indicating one reference signal from each CMR set that is associated with one of the two selected narrow beams. Herein, particular methods for efficiently making the measurements across the two antenna panels are disclosed.

### TECHNICAL FIELD

This application relates generally to wireless communication systems, including wireless communication systems implementing group-based beam reporting by UEs capable of multi-Rx chain DL reception.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table for determining a measurement period for SSBs in FR2, according to some embodiments of NR wireless communication systems.

FIG. 2 illustrates a table for determining a measurement period for CSI-RSs in FR2, according to some embodiments of NR wireless communication systems.

FIG. 3 illustrates a diagram of a UE that communicates with a network through a first TRP and a second TRP.

FIG. 4 illustrates a diagram visualizing a first CMR set and a second CMR set as may be provided to a UE by a network, according to some embodiments.

FIG. 5 illustrates a diagram of a UE that communicates with a first TRP and a second TRP, according to embodiments herein.

FIG. 6 illustrates a diagram of a UE that communicates with a first TRP and a second TRP, according to embodiments herein.

FIG. 7 illustrates a method of a UE, according to embodiments herein.

FIG. 8 illustrates a method of a UE, according to embodiments herein.

FIG. 9 illustrates a method of a RAN, according to embodiments herein.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some wireless communication systems may use multi-receive (Rx) chain downlink (DL) reception (e.g., support the simultaneous reception of two separate DL communications at two separate Rx chains of the UE). For example, some NR wireless communication systems may use multi-Rx chain DL reception in FR2 contexts. In some such systems, FR2-1 UEs with such simultaneous DL reception from different directions and with different quasi colocation (QCL) TypeD reference signals (RSs) on a single component carrier may be utilized.

With respect to such uses, various radio resource management (RRM) requirements may be considered, for example: Layer 1 (L1)-reference signal receive power (RSRP) measurement delay requirements; layer 3 (L3) measurement delay requirements, where a starting point may be enhancements related to L1-RSRP measurements (and where both cell detection delay and measurement period may be considered); radio link management (RLM) and beam failure detection (BFD)/candidate beam detection (CBD) requirements; scheduling/measurement restriction requirements; transmission configuration indicator (TCI) state switching delay requirements with dual TCI; and/or requirements for a receive timing difference between different directions (e.g., different QCL Type D RSs).

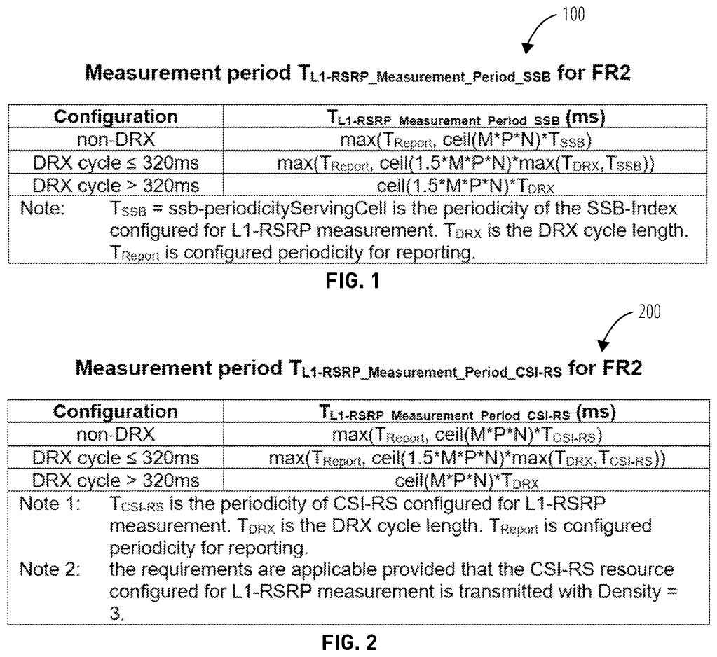

FIG. 1 illustrates a table 100 for determining a measurement period for synchronization signal blocks (SSBs) in FR2, according to some embodiments of NR wireless communication systems.

FIG. 2 illustrates a table 200 for determining a measurement period for channel state information reference signals (CSI-RSs) in FR2, according to some embodiments of NR wireless communication systems.

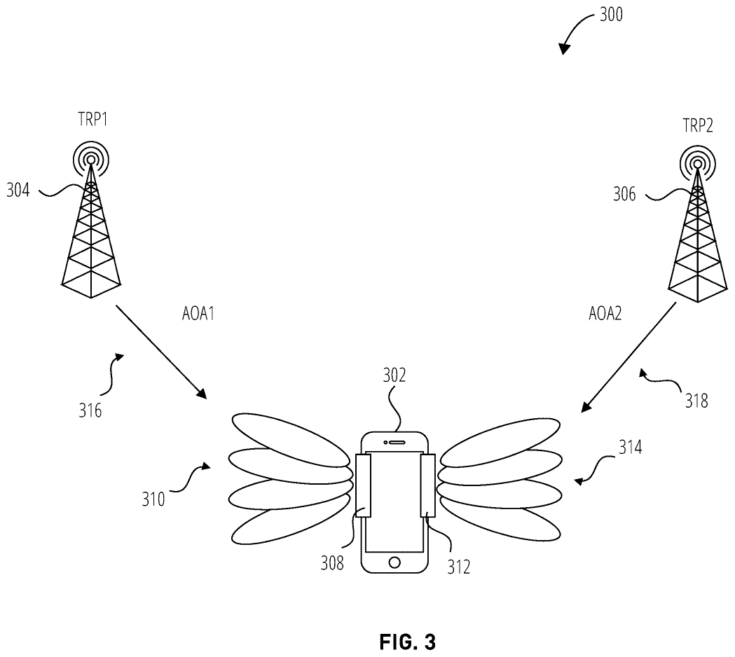

FIG. 3 illustrates a diagram 300 of a UE 302 that communicates with a network through a first transmission reception point (TRP) 304 and a second TRP 306. As illustrated, the UE 302 may be equipped with a first antenna panel 308, through which the UE 302 communicates with the first TRP 304 on one or more first narrow beams 310 and a second antenna panel 312 and a second antenna panel 312 through which the UE 302 communicates with the second TRP 306 on one or more second narrow beams 314.

The communications with each of the first TRP 304 and second TRP 306 may be, for example, multi-Rx chain DL receptions that occur simultaneously at the UE, according to embodiments considered herein. For example, the communications may include the first DL communications 316 from the first TRP 304 having a first angle of arrival (AOA) corresponding to reception at the first narrow beams 310, and second DL communications 318 from the second TRP 306 having a second AOA corresponding to reception at the second narrow beams 314 (and where the first DL communications 316 are occurring simultaneously to the second DL communications 318).

In the context of UEs capable of multi-Rx chain DL reception, various requirements related to group-based beam reporting (GBBR) may be considered. One aspect of such considerations relates to the manner in which the measurements for GBBR are performed. Elements relevant to this aspect may include, for example, a determination of any measurement delay for GBBR (e.g., a measurement delay for determining a beam pair to report). With respect to such elements, it may be that in a first option, a UE may use an L1-RSRP delay that provides for individualized narrow beam treatment across multiple antenna panels, as the UE does not know at the outset which beams may be ultimately be paired. In a second option, it may be recognized that due to an ability at the UE to perform measurements during simultaneous reception across two antenna panels, delay for purposes of L1-RSRP measurements for determining beam pairs may be comparatively reduced.

Systems and methods disclosed herein discuss the performance of and requirement for L1 measurements at a UE having multiple antenna panels. Various embodiments of performing an L1 measurement are discussed. In some embodiments, measurements by the UE are taken by the simultaneous use of two UE antenna panels (which may speed up the measurement process as opposed to cases where only one antenna panel at a time is used for measurements). Further, configurations (e.g., as provided by the network) for supporting various modes for L1 measurements with respect to UEs having multiple antenna panels are also discussed.

GBBR mechanisms described herein may operate with respect to configured channel measurement resource (CMR) sets that are provided to the UE by the network. For example, in such contexts, the measured RSs may be configured in two channel measurement resource (CMR) sets.

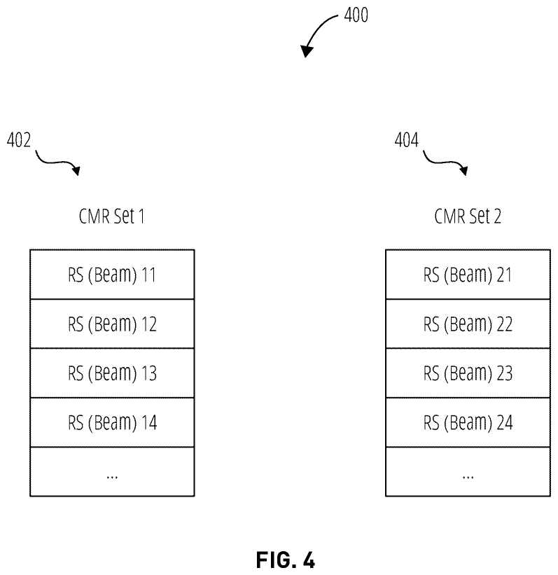

FIG. 4 illustrates a diagram 400 visualizing a first CMR set 402 and a second CMR set 404 as may be provided to the UE by a network, according to some embodiments. With respect to GBBR from the UE to the network, it may be that for each of one or more reported beam pairs reported by the UE, a first beam may be selected from the first CMR set 402 and a second beam may be selected from the second CMR set 404 (and note that within this constraint the UE may otherwise enjoy full flexibility in the selection of beams from the first CMR set 402 and the second CMR set 404).

As is illustrated in the diagram 400, each RS may be associated with a beam on which that RS is transmitted.

In some cases, it may be assumed that the RSs within one of the first CMR set 402 and the second CMR set 404 are non-overlapping in the time domain (e.g., no two of these RSs is sent in a same orthogonal frequency division multiplexing symbol), which may preserve compatibility as to UEs having/using only a single antenna panel at a time (and that thus may only form one beam direction at a time with analog beamforming).

In some cases, the RSs found in the first CMR set 402 and the second CMR set 404 may be SSBs (e.g., this may be the case in intra-cell multiple transmission reception point (mTRP) contexts). In some cases, the RSs found in the first CMR set 402 and the second CMR set 404 may be CSI-RSs.

Note that in certain cases where RSs from two CMR sets are configured to be transmitted in a same orthogonal frequency division multiplexing (OFDM) symbol, the UE may utilize a relatively longer measurement period for SSB/CSI-RS based L1-RSRP measurement.

In various embodiments discussed herein, the GBBR may proceed as follows. A UE may receive, from a network, first and second CMR sets. The first CMR set may identify first reference signals that are transmitted by a first TRP, while the second CMR set may identify second reference signals transmitted by a second TRP of the network.

The reference signals represented in the first CMR set and the second CMR set may be together transmitted periodically, which for various embodiments means that they are transmitted in bursts that each contain the reference signals of both CMR sets, where the bursts occur according to a configured periodicity. Note that this is meant to denote a togetherness of the signals in the time domain rather than in the spatial domain—as a spatial matter, the reference signals are each transmitted on one of the two TRPs (which may be spatially distant from each other). Examples of such periodic transmissions may include, for example, a synchronization signal (SS) burst that is transmitted across two TRPs in the case of SSBs, and/or a transmission of a grouping of CSI-RSs across two TRPs in the case of CSI-RSs.

The UE may then proceed to perform measurements of the first reference signals from the first CMR set and the second reference signals from the second CMR set using a plurality of narrow beams within a plurality of broader beams. Each of the broader beams (that define the sweep range for the corresponding narrower beams) may be oriented to a corresponding RS by the UE based on previous L3 measurements taken by the UE (e.g., for mobility purposes). The UE uses each of the broader beams on one of the first antenna panel of the UE and the second antenna panel of the UE. To enable this, the UE determines, based on the L3 measurements, a useable (e.g., in some cases, a “best fit”) correspondence between the incoming AOA of the reference signal corresponding to the broad beam and the associated antenna panel.

The narrow beams in each rough beam may then be set by the UE. The UE then performs measurements of the reference signals transmitted by the TRPs using the narrow beams. Note that in some cases, the number of narrow beams per rough beam (e.g., per reference signal) is less than or equal to a beam sweeping factor known to the UE. A narrow beam may be considered to be on an antenna panel that performs the measurement using the narrow beam (which is the antenna panel of the broad beam for that narrow beam, as has been described).

Once the narrow beams corresponding to the broader beams have been used to perform the measurements, the UE may then select, based on the measurements, a first narrow beam of the plurality of narrow beams that is on the first antenna panel and a second narrow beam of the plurality of narrow beams that is on the second antenna panel to use for simultaneous DL reception purposes. Further, the UE may also send, to the network, a beam report indicating a first selected reference signal of the first reference signals from the first CMR set (e.g., that is associated with/has been determined via measurement as described to be directed toward/be a good fit for the first narrow beam) and a second selected reference signal of the plurality of the second reference signals for the second CMR set (e.g., that is associated with/has been determined via measurement as described to be directed toward/be a good fit for the first narrow beam).

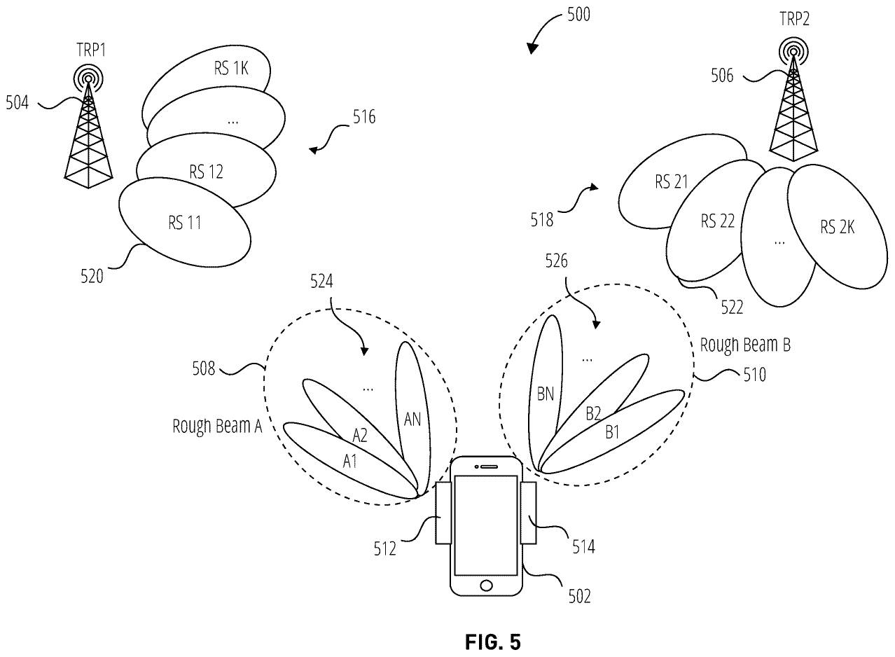

FIG. 5 illustrates a diagram 500 of a UE 502 that communicates with a first TRP 504 and a second TRP 506, according to embodiments herein. First reference signals 516 of a first CMR set that has been configured to the UE (illustrated as “RS 1X” in FIG. 3) may be transmitted by a first TRP 504, while second reference signals 518 of a second CMR set that has been configured to the UE (illustrated as “RS 2X” in FIG. 3) may be transmitted by the second TRP 506. The first reference signals 516 and the second reference signals 518 may be together transmitted periodically, as has been described. In the example illustrated in FIG. 5, the number of reference signals in each of the first CMR set and the second CMR set is K, such that the number of the first reference signals 516 transmitted by the first TRP 504 is K and the number of second reference signals 518 transmitted by the second TRP 506 is also K. Note that in other cases, the number of reference signals in the first CMR set and the second CMR set (and thus the number of reference signals transmitted by the first TRP 504 and the second TRP 506) may be different.

The diagram 500 further illustrates a first rough beam 508 on a first antenna panel 512 of the UE 502 and a second rough beam 510 on a second antenna panel 514 of the UE 502. The first rough beam 508 corresponds to one of the first reference signals 516 transmitted by the first TRP 504 (for example, a first reference signal 520 (“RS 11”) of the first reference signals 516 transmitted by the first TRP 504), while the second rough beam 510 corresponds to one of the second reference signals 518 transmitted by the second TRP 506 (for example, a second reference signal 522 (“RS 22”) of the second reference signals 518 transmitted by the second TRP 506).

The first narrow beams 524 in the first rough beam 508 and the second narrow beams 526 in the second rough beam 510 may be determined by the UE. In the case illustrated in FIG. 3, it is assumed that the UE 502 uses a number of narrow beams per rough beam that is equal to a beam sweeping factor N known to the UE. Accordingly, as illustrated, the UE 502 identifies a number N of first narrow beams 524 for the first rough beam 508 and a number N of second narrow beams 526 for the second rough beam 510.

Note that additional (unillustrated) narrow beams may also be determined by the UE relative to (unillustrated) additional rough beams corresponding to reference signals other than the first reference signal 520 and the second reference signal 522.

Then, the UE performs measurements of first reference signals 516 and the second reference signals 518 transmitted by the TRPs using the narrow beams (including the first narrow beams 524, second narrow beams 526, and the unillustrated narrow beams for other unillustrated rough beams).

Based on these measurements, the UE is enabled to select a first narrow beam on the first antenna panel 512 and a second narrow beam on the second antenna panel 514 to use simultaneously. To make this selection, the UE may evaluate channel characteristics of each of the narrow beams and determine that, for example, each was able to receive a selected reference signal with good reception and without too much interference from a use of the other narrow beam to receive another selected reference signal (where the selected reference signals may belong to different CMR sets).

The UE may also report the selected reference signals (e.g., one of the first reference signals 516 from the first CMR set and one of the second reference signals 518 of the second CMR set) to the network as a beam pair that is to be reported as part of GBBR.

Note that the analysis/selection of narrow beams and the reporting of a corresponding pair of selected reference signals based on the measurements may be performed more than once (such that the GBBR ultimately reports multiple useable beam pairs to the network). In some wireless communications systems, up to four useable beam pairs may be sent in a single beam report for GBBR.

As illustrated, the diagram 500 of FIG. 5 corresponds to a case with no overlap between the first rough beam 508 and the second rough beam 510.

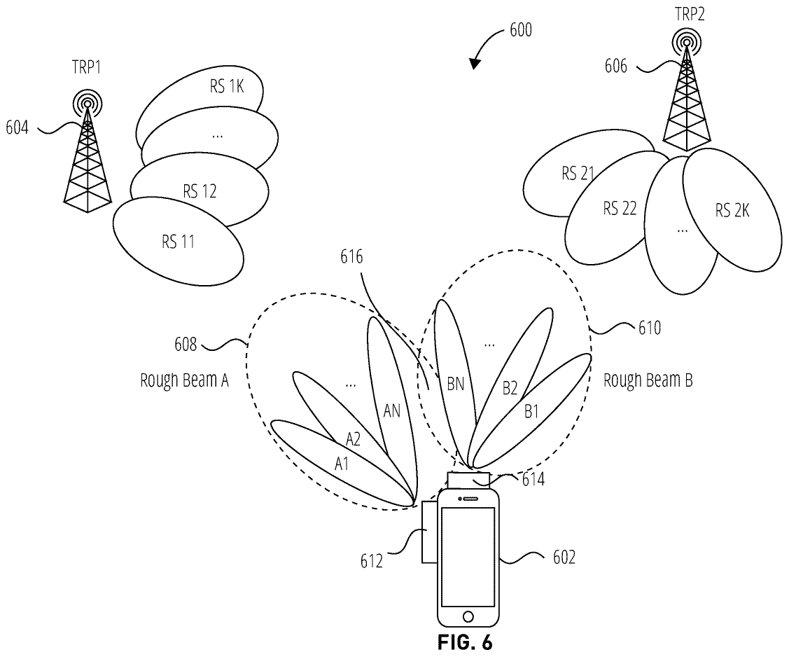

FIG. 6 illustrates a diagram 600 of a UE 602 that communicates with a first TRP 604 and a second TRP 606, according to embodiments herein. Differences between the UE 602 for FIG. 6 and the UE 502 of FIG. 5 include that, as illustrated, a first antenna panel 612 and a second antenna panel 614 of the UE 602 of FIG. 6 are located on the UE 602 in relatively different positioning from that of the first antenna panel 512 and the second antenna panel 514 of the UE 502 of FIG. 5 (the second antenna panel 614 is located at the top of the UE 602 of FIG. 6).

As illustrated in the diagram 600, due to the positioning of the first antenna panel 612 and the second antenna panel 614, the first rough beam 608 and the second rough beam 610 overlap 616. Note that it is possible that there could be some narrow beams that are shared/overlapped between such overlapping rough beams. It is recognized that in such cases, if measurements are performed on only one of these shared/overlapping narrow beams, a needed measurement period may be reduced (without losing any substantive measurement information that would otherwise be obtained).

Particular methods of performing L1 measurement within the framework illustrated and described with respect to FIG. 5 and FIG. 6 are now described.

### Non-Simultaneous L1 Measurement Using SSBs

A first method performs non-simultaneous L1 measurements of RSs that are SSBs. Under the first method, for group-based L1 measurement, it may be assumed that the SSBs (the measurement resources to be measured) may be configured based on prior L3 measurements. At such a stage, it may be that the UE has achieved time/frequency coordination with the cell via the L3 measurement procedure. Further, the network understands that the UE may receive in the directions of the reported L3 RS to be used by the TRPs.

In some examples, it may be assumed that the network configures two CMR sets for the UE to measure, each set having a number K of SSB resources. Further, it may be that the UE is to refine its beams according to a beam sweeping factor N (the UE may be allowed to test out up to N different narrow beams corresponding to each SSB to be measured). Note that in some cases, the UE may use N=8.

Under the first method, it may be assumed that at any one time, the UE may activate only one panel (and thus only perform one measurement on one narrow beam at a time).

Then, for every SS burst (or SSB period), the UE is able to test one narrow beam within the beam angle range of a rough beam obtained from the previous L3 measurement for each SSB resource. Accordingly, in such a case, the total number of SS bursts/SSB periods needed to utilize all the narrow beams is 2*K*N. In other words, the needed measurement period may be 2*K*N*T_{SSB}, where T_{SSB} is the SS burst/SSB periodicity (which may be determined at the UE based on an ssb-periodicityServingCell information element (IE) that is configured for the serving cell). Note that T_{SSB} is an example of an applicable reference signal periodicity T_{RS} for the case of SSB use as described.

It is noted that, in general, there is no inherent requirement that, as in the example just provided, the first CMR set and the second CMR set have a same number K of SSB resources. Accordingly, a more general understanding/use may be enabled by first denoting that the first CMR set has a first number K_{CMR1} of SSB resources while a second CMR set has a second number K_{CMR2} of SSB resources (and where, for example, K_{CMR1}≠K_{CMR2} in at least some cases). Then, the more general solution under the application above is that a total number of SS bursts/SSB periods needed is (K_{CMR1}+K_{CMR2})*N, and thus the total measurement period may be determined with (K_{CMR1}+K_{CMR2})*N*T_{SSB}.

### Simultaneous L1 Measurement Using SSBs

A second method performs simultaneous L1 measurements of RSs that are SSBs. Under the second method, for group-based L1 measurement, it may be assumed that the SSBs (the measurement resources to be measured) may be configured based on prior L3 measurements. At such a stage, it may be that the UE has achieved time/frequency coordination with the cell via the L3 measurement procedure. Further, the network understands that the UE may receive in the directions of the reported L3 RS to be used by the TRPs.

In some examples, it may be assumed that the network configures two CMR sets for the UE to measure, each set having a number K of SSB resources. Further, it may be that the UE is to refine its beams according to a beam sweeping factor N (the UE may be allowed to test out up to N different narrow beams corresponding to each SSB to be measured). Note that in some cases, the UE may use N=8.

Under the second method, it may be assumed the UE may simultaneously activate/use two antenna panels (and thus can perform two simultaneous measurements: a first measurement using a first narrow beam on a first of the two antenna panel and a second measurement using a second narrow beam on a second of the two antenna panels).

Under such circumstances, to reduce the measurement delay (e.g., in comparison with the first method), the UE may operate according to the following mechanisms. It may be assumed that for the first CMR set having K resources, there are K₁ SSBs that are supported by a first antenna panel (that correspond to rough beams of the UE that are on the first antenna panel) and K₂ SSBs that are supported by a second antenna panel of the UE (that correspond to rough beams of the UE that are on the second antenna panel), where K₁+K₂=K. Similarly, it may be assumed that for the second CMR set, there are K₃ SSBs that are supported by the second antenna panel (that correspond to rough beams of the UE that are on the second antenna panel) and K₄ SSBs that are supported by the first antenna panel of the UE (that correspond to rough beams of the UE that are on the first antenna panel), where K₃+K₄=K.

Under such circumstances, the UE may be configured to efficiently allocate measurements over time such that a useful set of measurements for GBBR can be assembled using only K*N SSB periodicities, such that an overall measurement period may be only K*N*T_{SSB}. For example, in a first case where K₁=K₃ and K₂=K₄, the UE may allocate measurements such that it always uses two antenna panels simultaneously in order to test out narrow beams. This corresponds to the use of K pairs of rough beams during the measurements, with each such pair of rough beams corresponding to one SSB from the first CMR set and a second SSB from the second CMR set.

In a second case where K₁>K₃ and K₂<K₄, the UE may use two antenna panels simultaneously in order to test out narrow beams corresponding to a number K₃+K₂ pairs of rough beams, with each such pair corresponding to one SSB from the first CMR set and a second SSB from the second CMR set. To achieve this, the UE may identify the number of K₃ SSBs and then select this number of top SSBs from among the K₁ SSBs from the first CMR set (in terms of the previous L3 measurements and/or any previous L1 measurements, if available). Further, the UE may also identify the number of K₂ SSBs and then select this number of top SSBs from among the K₄ SSBs from the second CMR set (in terms of the previous L3 measurements and/or any previous L1 measurements, if available). Measurements in rough beams for the top SSBs from the K₁ and the K₄ SSBs can then be performed (on the first antenna panel) simultaneously with measurements in rough beams for all the K₂ and the K₃ SSBs (on the second antenna panel) in order to gather a useful set of measurements for the GBBR. Note than any remaining ones of the K*N periodicities may be used to perform measurements in rough beams for one or more remaining ones of the K₁ and the K₄ SSBs on the first antenna panel that were not simultaneously used with the rough beams for the K₂ and the K₃ SSBs (where (K−K₃−K₂)*N such periodicities remain available/a time period (K−K₃−K₂)*N*T_{SSB} remains available).

In a third case where K₁<K₃ and K₂>K₄, the UE may use two antenna panels simultaneously in order to test out narrow beams corresponding to a number K₄+K₁ pairs of rough beams, with each such pair corresponding to one SSB from the first CMR set and a second SSB from the second CMR set. To achieve this, the UE may identify the number of K₁ SSBs and then select this number of top SSBs from among the K₃ SSBs from the second CMR set (in terms of the previous L3 measurements and/or any previous L1 measurements, if available). Further, the UE may also identify the number of K₄ SSBs and then select this number of top SSBs from among the K₂ SSBs from the first CMR set (in terms of the previous L3 measurements and/or any previous L1 measurements, if available). Measurements in rough beams for the top SSBs from the K₂ and the K₃ SSBs can then be performed (on the second antenna panel) simultaneously with measurements in rough beams for all the K₁ and the K₄ SSBs (on the first antenna panel) in order to gather a useful set of measurements for the GBBR. Note than any remaining ones of the K*N periodicities may be used to perform measurements in rough beams for one or more remaining ones of the K₂ and the K₃ SSBs on the second antenna panel that were not simultaneously used with the rough beams for the K₁ and the K₄ SSBs (where (K−K₁−K₄)*N such periodicities remain available/a time period (K−K₁−K₄)*N*T_{SSB} remains available).

It is noted that, in general, there is no inherent requirement that, in the examples where K₁>K₃ and K₂<K₄ and where K₁<K₃ and K₂>K₄ as just provided, the first CMR set and the second CMR set have a same number K of SSB resources. Accordingly, a more general understanding/use may be enabled by first denoting that the first CMR set has a first number K_{CMR1} of SSB resources while a second CMR set has a second number K_{CMR2} of SSB resources (and where, for example, K_{CMR1}≠K_{CMR2} in at least some cases). Then, the more general solution under the application above (that contemplates this potential mismatch in SSB number) is that a total number of SS bursts/SSB periods used is max(K_{CMR1},K_{CMR2})*N, and thus the total measurement period may be determined with max(K_{CMR1},K_{CMR2})*N*T_{SSB}.

Accordingly, for the case where K₁>K₃ and K₂<K₄, any remaining periodicities used to perform measurements in rough beams for one or more remaining ones of the K₁ and the K₄ SSBs on the first antenna panel that are not simultaneously used with the rough beams for the K₂ and the K₃ SSBs can be determined using (max(K_{CMR1},K_{CMR2})−K₃−K₂)*N (with the corresponding time period being (max(K_{CMR1},K_{CMR2})−K₃−K₂)*N*T_{SSB}). Similarly, for the case where K₁<K₃ and K₂≥K₄, any remaining periodicities used to perform measurements in rough beams for one or more remaining ones of the K₂ and the K₃ SSBs on the second antenna panel that are not simultaneously used with the rough beams for the K₁ and the K₄ SSBs can be determined using (max(K_{CMR1},K_{CMR2})−K₁−K₄)*N (with the corresponding time period being (max(K_{CMR1},K_{CMR2})−K₁−K₄)*N*T_{SSB}).

### Non-Simultaneous L1 Measurement Using CSI-RSs

A third method performs non-simultaneous L1 measurements of RSs that are CSI-RSs. Under the third method, for group-based L1 measurement, it may be assumed that the CSI-RSs (the measurement resources to be measured) may be configured based on prior L3 measurements. At such a stage, it may be that the UE has achieved time/frequency coordination with the cell via the L3 measurement procedure. Further, the network understands that the UE may receive in the directions of the reported L3 RS to be used by the TRPs.

In some examples, it may be assumed that the network configures two CMR sets for the UE to measure, each set having a number K of CSI-RSs.

Under the third method, it may be assumed that at any one time, the UE may activate only one panel (and thus only perform one measurement on one narrow beam at a time).

Further, it may be that the UE is to refine its beams according to a beam sweeping factor N (the UE may be allowed to test out up to N different narrow beams for each CSI-RS to be measured). With respect to the use of CSI-RSs, two cases for the value of N may be possible.

In a first case, a higher layer parameter for CSI-RS repetition is set to ‘OFF.’ In such cases, the UE may understand that a beam sweeping factor N=1 applies.

In a second case, the higher layer parameter for CSI-RS repetition is set to ‘ON.’ In such cases, the UE may understand that a beam sweeping factor of N=ceil (maxNumberRxBeam/Nres_per_set) applies, where maxNumberRxBeam indicates a preferred number of non-zero power (NZP) CSI-RS resource repetitions per CSI-RS resource set at the UE, and Nres_per_set is the number of resources in the resource set.

A periodicity related to the CSI-RSs may be denoted T_{CSI-RS}. In some cases, the two CSI-RS sets of the two CMR sets use a same periodicity (that is thus denoted by T_{CSI-RS}). In alternative cases, the two CSI-RS sets of the two CMR sets use a different periodicity. In such cases, the larger CSI-RS periodicity of the two CMR sets is denoted by T_{CSI-RS}. Note that T_{CSI-RS} is an example of an applicable reference signal periodicity T_{RS} for the case of CSI-RS use as described.

Then, for every T_{CSI-RS}, the UE is able to test one narrow beam within the beam angle range of a rough beam obtained from the previous L3 measurement for each CSI-RS. Accordingly, in such a case, the total number of T_{CSI-RS} needed is 2*K*N. In other words, the needed measurement period may be 2*K*N*T_{CSI-RS}.

It is noted that there is no inherent requirement that, as in the example just provided, the first CMR set and the second CMR set have a same number K of SSB resources. Accordingly, a more general understanding/use may be denoted by recognizing that the first CMR set has a first number K_{CMR1} of SSB resources while a second CMR set has a second number K_{CMR2} of SSB resources (and where, for example, K_{CMR1}≠K_{CMR2} in at least some cases). Then, the more general solution under the application above is that a total number of T_{CSI-RS} needed is (K_{CMR1}+K_{CMR2})*N, and thus the total measurement period may be determined with (K_{CMR1}+K_{CMR2})*N*T_{CSI-RS}.

### Simultaneous L1 Measurement Using CSI-RSs

A fourth method performs simultaneous L1 measurements of RSs that are CSI-RSs. Under the fourth method, for group-based L1 measurement, it may be assumed that the CSI-RSs (the measurement resources to be measured) may be configured based on prior L3 measurements. At such a stage, it may be that the UE has achieved time/frequency coordination with the cell via the L3 measurement procedure. Further, the network understands that the UE may receive in the directions of the reported L3 RS to be used by the TRPs.

In some examples, it may be assumed that the network configures two CMR sets for the UE to measure, each set having a number K of CSI-RSs.

Further, it may be that the UE is to refine its beams according to a beam sweeping factor N (the UE may be allowed to test out up to N different narrow beams for each CSI-RS to be measured). With respect to the use of CSI-RSs, two cases for the value of N may be possible.

In a first case, a higher layer parameter for CSI-RS repetition is set to ‘OFF.’ In such cases, the UE may understand that a beam sweeping factor N=1 applies.

In a second case, the higher layer parameter for CSI-RS repetition is set to ‘ON.’ In such cases, the UE may understand that a beam sweeping factor of N=ceil (maxNumberRxBeam/Nres_per_set) applies, where maxNumberRxBeam indicates a preferred number of non-zero power (NZP) CSI-RS resource repetitions per CSI-RS resource set at the UE, and Nres_per_set is the number of resources in the resource set.

In some cases, the two CSI-RS sets of the two CMR sets have a same periodicity (that is thus denoted by T_{CSI-RS}). In alternative cases, the two CSI-RS sets of the two CMR sets have a different periodicity. In such cases, the larger CSI-RS periodicity of the two CMR sets is denoted by T_{CSI-RS}.

Under the fourth method, it may be assumed the UE may simultaneously activate/use two antenna panels (and thus can perform two simultaneous measurements: a first measurement using a first narrow beam on a first of the two antenna panel and a second measurement using a second narrow beam on a second of the two antenna panels).

Under such circumstances, to reduce the measurement delay (e.g., in comparison with the third method), the UE may operate according to the following mechanisms. It may be assumed that for the first CMR set having K resources, there are K₁ CSI-RSs that are supported by a first antenna panel (that correspond to rough beams of the UE that are on the first antenna panel) and K₂ CSI-RSs that are supported by a second antenna panel of the UE (that correspond to rough beams of the UE that are on the second antenna panel), where K₁+K₂=K. Similarly, it may be assumed that for the second CMR set, there are K₃ CSI-RSs that are supported by the second antenna panel (that correspond to rough beams of the UE that are on the second antenna panel) and K₄ CSI-RSs that are supported by the first antenna panel of the UE (that correspond to rough beams of the UE that are on the first antenna panel), where K₃+K₄=K.

Under such circumstances, the UE may be configured to efficiently allocate measurements over time such that a useful set of measurements for GBBR can be assembled using only (K*N) T_{CSI-RSS}, such that an overall measurement period may be only K*N*T_{CSI-RS}.

For example, in a first case where K₁=K₃ and K₂=K₄, the UE may allocate measurements such that it always uses two antenna panels simultaneously in order to test out narrow beams. This corresponds to the use of K pairs of rough beams for the measurements, with each such pair of rough beams corresponding to one CSI-RS from the first CMR set and a second CSI-RS from the second CMR set.

In a second case where K₁>K₃ and K₂<K₄, the UE may use two antenna panels simultaneously in order to test out narrow beams corresponding to a number K₃+K₂ pairs of rough beams, with each such pair corresponding to one CSI-RS from the first CMR set and a second CSI-RS from the second CMR set. To achieve this, the UE may identify the number of K₃ CSI-RSs and then select this number of top CSI-RSs from among the K₁ CSI-RSs from the first CMR set (in terms of the previous L3 measurements and/or any previous L1 measurements, if available). Further, the UE may also identify the number of K₂ CSI-RSs and then select this number of top CSI-RSs from among the K₄ CSI-RSs from the second CMR set (in terms of the previous L3 measurements and/or any previous L1 measurements, if available). Measurements in rough beams for the top CSI-RSs from the K₁ and the K₄ SSBs can then be performed (on the first antenna panel) simultaneously with measurements in rough beams for all the K₂ and the K₃ CSI-RSs (on the second antenna panel) in order to gather a useful set of measurements for the GBBR. Note than any remaining ones of the K*N periodicities may be used to perform measurements in rough beams for one or more remaining ones of the K₁ and the K₄ CSI-RSs on the first antenna panel that were not simultaneously used with the rough beams for the K₂ and the K₃ CSI-RSs (where (K−K₃−K₂)*N such periodicities remain available/a time period (K−K₃−K₂)*N*T_{CSI-RS} remains available).

In a third case where K₁<K₃ and K₂>K₄, the UE may use two antenna panels simultaneously in order to test out narrow beams corresponding to a number K₄+K₁ pairs of rough beams, with each such pair corresponding to one CSI-RSs from the first CMR set and a second CSI-RSs from the second CMR set. To achieve this, the UE may identify the number of K₁ SSBs and then select this number of top CSI-RSs from among the K₃ SSBs from the second CMR set (in terms of the previous L3 measurements and/or any previous L1 measurements, if available). Further, the UE may also identify the number of K₄ CSI-RSs and then select this number of top CSI-RSs from among the K₂ SSBs from the first CMR set (in terms of the previous L3 measurements and/or any previous L1 measurements, if available). Measurements in rough beams for the top CSI-RSs from the K₂ and the K₃ SSBs can then be performed (on the second antenna panel) simultaneously with measurements in rough beams for all the K₁ and the K₄ CSI-RSs (on the first antenna panel) in order to gather a useful set of measurements for the GBBR. Note than any remaining ones of the K*N periodicities may be used to perform measurements in rough beams for one or more remaining ones of the K₂ and the K₃ CSI-RSs on the second antenna panel that were not simultaneously used with the rough beams for the K₁ and the K₄ CSI-RSs (where (K−K₁−K₄)*N such periodicities remain available/a time period (K−K₁−K₄)*N*T_{CSI-RS} remains available).

It is noted that there is no inherent requirement that, in the examples where K₁>K₃ and K₂<K₄ and where K₁<K₃ and K₂>K₄ as just provided, the first CMR set and the second CMR set have a same number K of SSB resources. Accordingly, a more general understanding/use may be enabled by first denoting that the first CMR set has a first number K_{CMR1} of SSB resources while a second CMR set has a second number K_{CMR2} of SSB resources (and where, for example, K_{CMR1}+K_{CMR2} in at least some cases). Then, the more general solution under the application above (that contemplates this potential mismatch in SSB number) is that a total number of T_{CSI-RSS} used is max(K_{CMR1}, K_{CMR2})*N, and thus the total measurement period may be determined with max(K_{CMR1}, K_{CMR2})*N*T_{CSI-RS}.

Accordingly, for the case where K₁>K₃ and K₂<K₄, any remaining periodicities used to perform measurements in rough beams for one or more remaining ones of the K₁ and the K₄ CSI-RSs on the first antenna panel that are not simultaneously used with the rough beams for the K₂ and the K₃ CSI-RSs can be determined using (max(K_{CMR1},K_{CMR2})−K₃−K₂)*N (with the corresponding time period being (max(K_{CMR1},K_{CMR2})−K₃−K₂)*N*T_{CSI-RS}). Similarly, for the case where K₁<K₃ and K₂>K₄, any remaining periodicities used to perform measurements in rough beams for one or more remaining ones of the K₂ and the K₃ CSI-RSs on the second antenna panel that are not simultaneously used with the rough beams for the K₁ and the K₄ CSI-RSs can be determined using (max(K_{CMR1},K_{CMR2})−K₁−K₄)*N (with the corresponding time period being (max(K_{CMR1},K_{CMR2})−K₁−K₄)*N*T_{CSI-RS}).

### Network Configuration Aspects

It is noted that reducing the measurement delay for the GBBR accordingly speeds up the multiple input multiple output (MIMO) configuration (consider, e.g., some NR wireless communication systems where GBBR is a prerequisite for the network to configure up to 4-layer MIMO to the UE). Therefore, to enable network configuration/control for reducing such measurement delays where possible, it is beneficial provide the network the capability/ability to indicate to a multi-Rx chain DL reception capable UE one of various modes for GBBR to use, as will now be explained.

In some such cases, the network may provide the UE with an indication that the UE is to activate only one antenna panel at a time for measurements of reference signals during each periodic transmission of the reference signals (e.g., according to methods disclosed herein).

In other such cases, the network may provide the UE with an indication that the UE is to simultaneously use a first antenna panel and a second antenna panel for measurements of reference signals during periodic transmissions of the reference signals (e.g., according to methods disclosed herein).

Across various possible embodiments, such indications may be sent to the UE by the network in any of radio resource control (RRC) signaling, medium access control control elements (MAC-CEs), and/or in downlink control information (DCI).

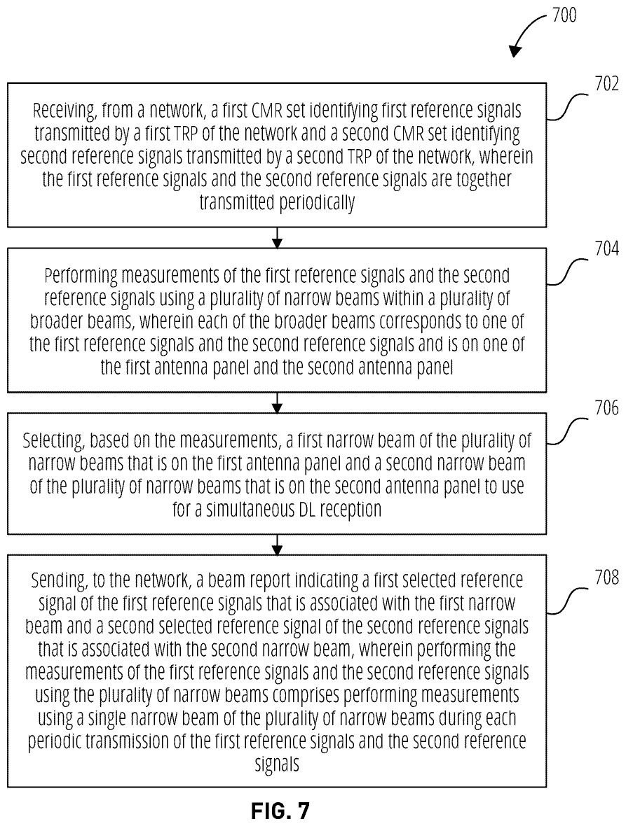

FIG. 7 illustrates a method 700 of a UE, according to embodiments herein. The method 700 includes receiving 702, from a network, a first CMR set identifying first reference signals transmitted by a first TRP of the network and a second CMR set identifying second reference signals transmitted by a second TRP of the network, wherein the first reference signals and the second reference signals are together transmitted periodically. The method 700 further includes performing 704 measurements of the first reference signals and the second reference signals using a plurality of narrow beams within a plurality of broader beams, wherein each of the broader beams corresponds to one of the first reference signals and the second reference signals and is on one of the first antenna panel and the second antenna panel. The method 700 further includes selecting 706, based on the measurements, a first narrow beam of the plurality of narrow beams that is on the first antenna panel and a second narrow beam of the plurality of narrow beams that is on the second antenna panel to use for a simultaneous DL reception. The method 700 further includes sending 708, to the network, a beam report indicating a first selected reference signal of the first reference signals that is associated with the first narrow beam and a second selected reference signal of the second reference signals that is associated with the second narrow beam, wherein performing the measurements of the first reference signals and the second reference signals using the plurality of narrow beams comprises performing measurements using a single narrow beam of the plurality of narrow beams during each periodic transmission of the first reference signals and the second reference signals.

In some embodiments of the method 700, wherein the measurements of the first reference signals and the second reference signals using the plurality of narrow beams occur within a time period (K_{CMR1}+K_{CMR2})*N*T_{RS}, where: K_{CMR1} is a number of the first reference signals of the first CMR set; K_{CMR2} is a number of the second reference signals of the second CMR set; Nis a beam sweeping factor at the UE; and T_{RS} is a periodicity for the periodic transmissions of the first reference signals and the second reference signals.

In some embodiments of the method 700, a first number of the first reference signals of the first CMR set is different than a second number of the second reference signals in the second CMR set.

In some embodiments, the method 700 further includes performing L3 measurement with respect to the first reference signals and the second reference signals to identify the plurality of broader beams.

In some embodiments of the method 700, a number of the plurality of narrow beams that is in each of the plurality of broader beams is less than or equal to a beam sweeping factor for the first reference signals and the second reference signals that is used at the UE.

In some embodiments of the method 700, the first reference signals and the second reference signals comprise a plurality of SSBs.

In some embodiments of the method 700, the first reference signals and the second reference signals comprise a plurality of CSI-RSs.

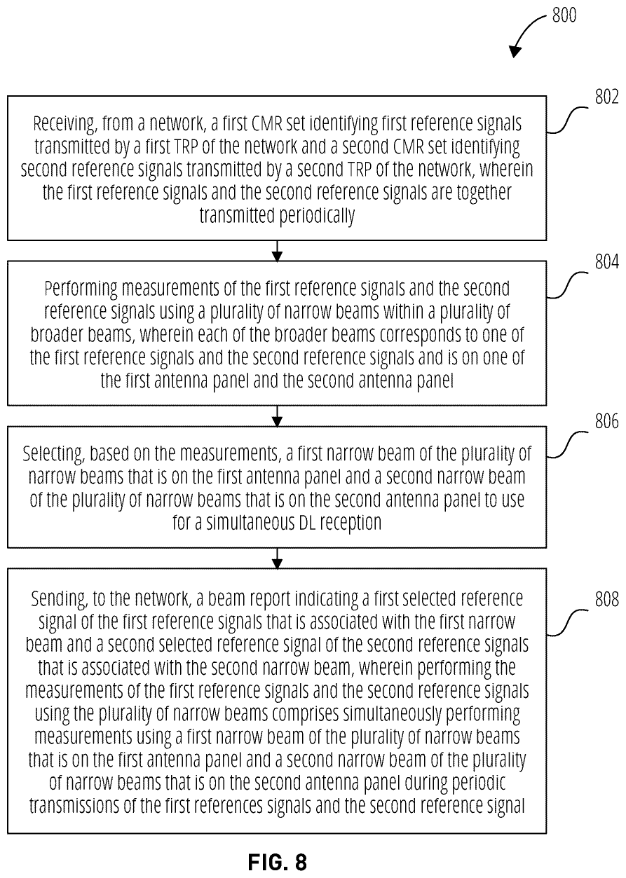

FIG. 8 illustrates a method 800 of a UE, according to embodiments herein. The method 800 includes receiving 802, from a network, a first CMR set identifying first reference signals transmitted by a first TRP of the network and a second CMR set identifying second reference signals transmitted by a second TRP of the network, wherein the first reference signals and the second reference signals are together transmitted periodically. The method 800 further includes performing 804 measurements of the first reference signals and the second reference signals using a plurality of narrow beams within a plurality of broader beams, wherein each of the broader beams corresponds to one of the first reference signals and the second reference signals and is on one of the first antenna panel and the second antenna panel. The method 800 further includes selecting 806, based on the measurements, a first narrow beam of the plurality of narrow beams that is on the first antenna panel and a second narrow beam of the plurality of narrow beams that is on the second antenna panel to use for a simultaneous DL reception. The method 800 further includes sending 808, to the network, a beam report indicating a first selected reference signal of the first reference signals that is associated with the first narrow beam and a second selected reference signal of the second reference signals that is associated with the second narrow beam, wherein performing the measurements of the first reference signals and the second reference signals using the plurality of narrow beams comprises simultaneously performing measurements using a first narrow beam of the plurality of narrow beams that is on the first antenna panel and a second narrow beam of the plurality of narrow beams that is on the second antenna panel during periodic transmissions of the first references signals and the second reference signals.

In some embodiments of the method 800, the measurements of the first reference signals and the second reference signals using the plurality of narrow beams occur within a time period max(K_{CMR1},K_{CMR2})*N*T_{RS}, where: K_{CMR1} is a number of the first reference signals of the first CMR set; K_{CMR2} is a number of the second reference signals of the second CMR set; Nis a beam sweeping factor at the UE; and T_{RS} is a periodicity for the periodic transmissions of the first reference signals and the second reference signals.

In some embodiments of the method 800, a first number of the first reference signals of the first CMR set is different than a second number of the second reference signals in the second CMR set.

In some embodiments, the method 800 further includes performing L3 measurement with respect to the first reference signals and the second reference signals to identify the plurality of broader beams.

In some embodiments of the method 800, a number of the plurality of narrow beams that is in each of the plurality of broader beams is less than or equal to a beam sweeping factor for the first reference signals and the second reference signals that is used at the UE.

In some embodiments of the method 800, the first reference signals and the second reference signals comprise a plurality of SSBs.

In some embodiments of the method 800, the first reference signals and the second reference signals comprise a plurality of CSI-RSs.

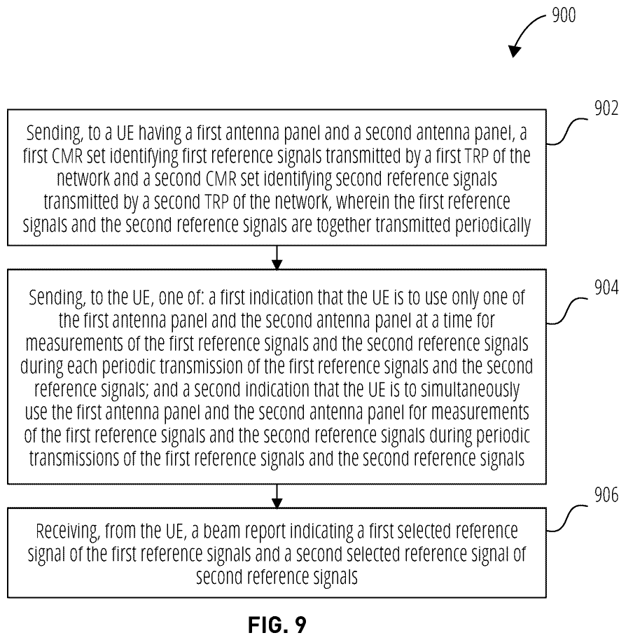

FIG. 9 illustrates a method 900 of a RAN, according to embodiments herein. The method 900 includes sending 902, to a UE having a first antenna panel and a second antenna panel, a first CMR set identifying first reference signals transmitted by a first TRP of the network and a second CMR set identifying second reference signals transmitted by a second TRP of the network, wherein the first reference signals and the second reference signals are together transmitted periodically. The method 900 further includes sending 904, to the UE, one of: a first indication that the UE is to use only one of the first antenna panel and the second antenna panel at a time for measurements of the first reference signals and the second reference signals during each periodic transmission of the first reference signals and the second reference signals; and a second indication that the UE is to simultaneously use the first antenna panel and the second antenna panel for measurements of the first reference signals and the second reference signals during periodic transmissions of the first reference signals and the second reference signals. The method 900 further includes receiving 906, from the UE, a beam report indicating a first selected reference signal of the first reference signals and a second selected reference signal of second reference signals.

In some embodiments of the method 900, a first number of the first reference signals of the first CMR set is different than a second number of the second reference signals in the second CMR set.

In some embodiments of the method 900, the first reference signals and the second reference signals comprise a plurality of SSBs.

In some embodiments of the method 900, the first reference signals and the second reference signals comprise a plurality of CSI-RSs.

In some embodiments of the method 900, the one of the first indication and the second indication is sent to the UE in one of RRC signaling, a MAC-CE, and DCI.

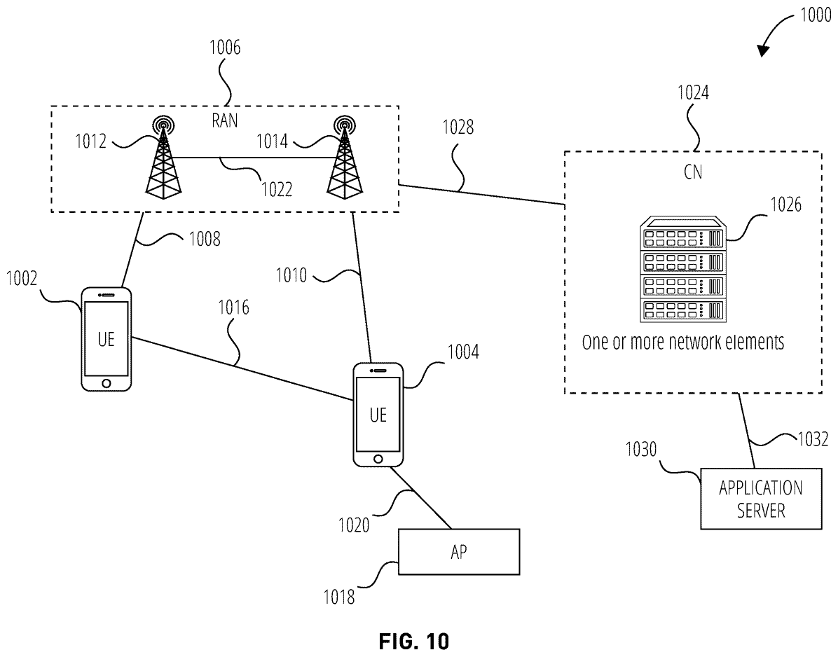

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using OFDM communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

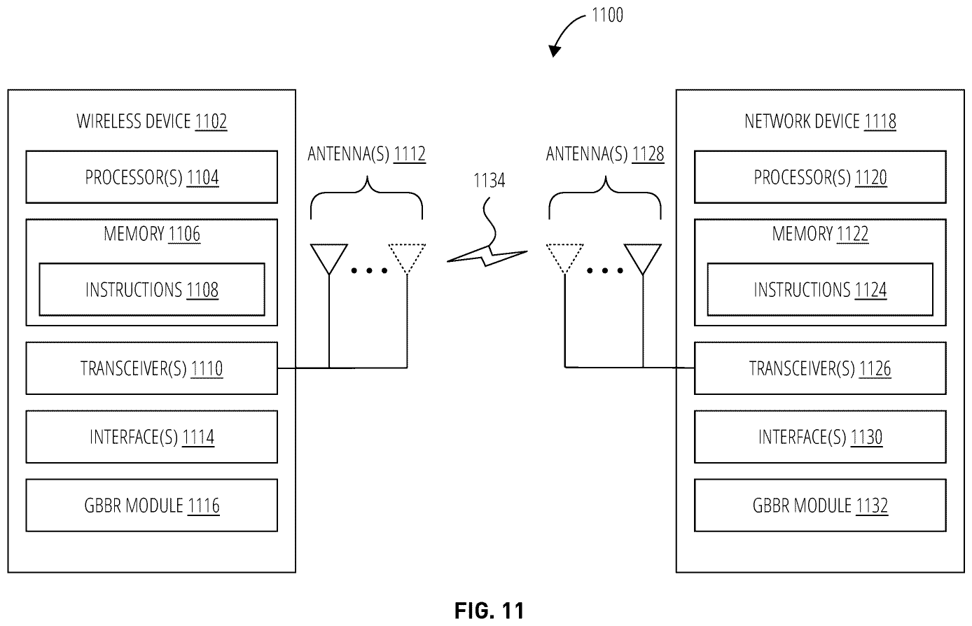

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter circuitry and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include a GBBR module 1116. The GBBR module 1116 may be implemented via hardware, software, or combinations thereof. For example, the GBBR module 1116 may be implemented as a processor, circuit, and/or instructions 1108 stored in the memory 1106 and executed by the processor(s) 1104. In some examples, the GBBR module 1116 may be integrated within the processor(s) 1104 and/or the transceiver(s) 1110. For example, the GBBR module 1116 may be implemented by a combination of software components (e.g., executed by a DSP or a general processor) and hardware components (e.g., logic gates and circuitry) within the processor(s) 1104 or the transceiver(s) 1110.

The GBBR module 1116 may be used for various aspects of the present disclosure, for example, aspects of FIG. 1 through FIG. 9. The GBBR module 1116 may be configured to cause the wireless device 1102 to receive a first CMR set identifying first reference signals transmitted by a first TRP of the network and a second CMR set identifying second reference signals transmitted by a second TRP of the network, wherein the first reference signals and the second reference signals are together transmitted periodically; to perform measurements of the first reference signals and the second reference signals using a plurality of narrow beams within a plurality of broader beams, wherein each of the broader beams corresponds to one of the first reference signals and the second reference signals and is on one of the first antenna panel and the second antenna panel; select, based on the measurements, a first narrow beam of the plurality of narrow beams that is on the first antenna panel and a second narrow beam of the plurality of narrow beams that is on the second antenna panel to use for a simultaneous DL reception; and/or to send to the network, a beam report indicating a first selected reference signal of the first reference signals that is associated with the first narrow beam and a second selected reference signal of the second reference signals that is associated with the second narrow beam, where in some cases performing the measurements of the first reference signals and the second reference signals using the plurality of narrow beams comprises performing measurements using a single narrow beam of the plurality of narrow beams during each periodic transmission of the first reference signals and the second reference signals, and where in some cases performing the measurements of the first reference signals and the second reference signals using the plurality of narrow beams comprises simultaneously performing measurements using a first narrow beam of the plurality of narrow beams that is on the first antenna panel and a second narrow beam of the plurality of narrow beams that is on the second antenna panel during periodic transmissions of the first references signals and the second reference signals, in the manners described herein.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter circuitry and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include a GBBR module 1132. The GBBR module 1132 may be implemented via hardware, software, or combinations thereof. For example, the GBBR module 1132 may be implemented as a processor, circuit, and/or instructions 1124 stored in the memory 1122 and executed by the processor(s) 1120. In some examples, the GBBR module 1132 may be integrated within the processor(s) 1120 and/or the transceiver(s) 1126. For example, the GBBR module 1132 may be implemented by a combination of software components (e.g., executed by a DSP or a general processor) and hardware components (e.g., logic gates and circuitry) within the processor(s) 1120 or the transceiver(s) 1126.

The GBBR module 1132 may be used for various aspects of the present disclosure, for example, aspects of FIG. 1 through FIG. 9. The GBBR module 1132 may be configured to cause the network device 1118 send, to a UE having a first antenna panel and a second antenna panel, a first CMR set identifying first reference signals transmitted by a first TRP of the network and a second CMR set identifying second reference signals transmitted by a second TRP of the network, wherein the first reference signals and the second reference signals are together transmitted periodically; to send, to the UE, one of: a first indication that the UE is to use only one of the first antenna panel and the second antenna panel at a time for measurements of the first reference signals and the second reference signals during each periodic transmission of the first reference signals and the second reference signals; and a second indication that the UE is to simultaneously use the first antenna panel and the second antenna panel for measurements of the first reference signals and the second reference signals during periodic transmissions of the first reference signals and the second reference signals; and/or to receive, from the UE, a beam report indicating a first selected reference signal of the first reference signals and a second selected reference signal of second reference signals, in the manners described herein.

Embodiments contemplated herein include an apparatus comprising means to perform one or more elements of any of the method 700 and the method 800. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 700 and the method 800. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of any of the method 700 and the method 800. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 700 and the method 800. This apparatus may be, for example, an apparatus of a UE (such as a wireless device 1102 that is a UE, as described herein).

Embodiments contemplated herein include a signal as described in or related to one or more elements of any of the method 700 and the method 800.

Embodiments contemplated herein include a computer program or computer program product comprising instructions, wherein execution of the program by a processor is to cause the processor to carry out one or more elements of any of the method 700 and the method 800. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

Embodiments contemplated herein include an apparatus comprising means to perform one or more elements of the method 900. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the method 900. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a base station (such as a network device 1118 that is a base station, as described herein).

Embodiments contemplated herein include a signal as described in or related to one or more elements of the method 900.

Embodiments contemplated herein include a computer program or computer program product comprising instructions, wherein execution of the program by a processing element is to cause the processing element to carry out one or more elements of the method 900. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) having a first antenna panel and a second antenna panel, comprising:
receiving, from a network, a first channel measurement resource (CMR) set identifying first reference signals transmitted by a first TRP of the network and a second CMR set identifying second reference signals transmitted by a second TRP of the network, wherein the first reference signals and the second reference signals are together transmitted periodically;
performing measurements of the first reference signals and the second reference signals using a plurality of narrow beams within a plurality of broader beams, wherein each of the broader beams corresponds to one of the first reference signals and the second reference signals and is on one of the first antenna panel and the second antenna panel;
selecting, based on the measurements, a first narrow beam of the plurality of narrow beams that is on the first antenna panel and a second narrow beam of the plurality of narrow beams that is on the second antenna panel to use for a simultaneous downlink (DL) reception; and
sending, to the network, a beam report indicating a first selected reference signal of the first reference signals that is associated with the first narrow beam and a second selected reference signal of the second reference signals that is associated with the second narrow beam;
wherein performing the measurements of the first reference signals and the second reference signals using the plurality of narrow beams comprises performing measurements using a single narrow beam of the plurality of narrow beams during each periodic transmission of the first reference signals and the second reference signals.

2. The method of claim 1, wherein the measurements of the first reference signals and the second reference signals using the plurality of narrow beams occur within a time period
$$( {K}_{CMR 1} + {K}_{CMR 2} ) * N * {T}_{RS}$$
where:
K_{CMR1} is a first number of the first reference signals of the first CMR set;
K_{CMR2} is a second number of the second reference signals of the second CMR set;
N is a beam sweeping factor at the UE; and
T_{RS} is a periodicity for the periodic transmissions of the first reference signals and the second reference signals.

3. The method of claim 1, wherein a first number of the first reference signals of the first CMR set is different than a second number of the second reference signals in the second CMR set.

4. The method of claim 1, further comprising performing layer 3 (L3) measurement with respect to the first reference signals and the second reference signals to identify the plurality of broader beams.

5. The method of claim 1, wherein a number of the plurality of narrow beams that is in each of the plurality of broader beams is less than or equal to a beam sweeping factor for the first reference signals and the second reference signals that is used at the UE.

6. The method of claim 1, wherein the first reference signals and the second reference signals comprise a plurality of synchronization signal blocks (SSBs).

7. The method of claim 1, wherein the first reference signals and the second reference signals comprise a plurality of channel state information reference signals (CSI-RSs).

8. A method of a user equipment (UE) having a first antenna panel and a second antenna panel, comprising:
receiving, from a network, a first channel measurement resource (CMR) set identifying first reference signals transmitted by a first TRP of the network and a second CMR set identifying second reference signals transmitted by a second TRP of the network, wherein the first reference signals and the second reference signals are together transmitted periodically;
performing measurements of the first reference signals and the second reference signals using a plurality of narrow beams within a plurality of broader beams, wherein each of the broader beams corresponds to one of the first reference signals and the second reference signals and is on one of the first antenna panel and the second antenna panel;
selecting, based on the measurements, a first narrow beam of the plurality of narrow beams that is on the first antenna panel and a second narrow beam of the plurality of narrow beams that is on the second antenna panel to use for a simultaneous downlink (DL) reception; and
sending, to the network, a beam report indicating a first selected reference signal of the first reference signals that is associated with the first narrow beam and a second selected reference signal of the second reference signals that is associated with the second narrow beam;
wherein performing the measurements of the first reference signals and the second reference signals using the plurality of narrow beams comprises simultaneously performing measurements using a first narrow beam of the plurality of narrow beams that is on the first antenna panel and a second narrow beam of the plurality of narrow beams that is on the second antenna panel during periodic transmissions of the first reference signals and the second reference signals.

9. The method of claim 8, wherein the measurements of the first reference signals and the second reference signals using the plurality of narrow beams occur within a time period
$$max ( {K}_{CMR 1} , {K}_{CMR 2} ) * N * {T}_{RS}$$
where:
K_{CMR1} is a first number of the first reference signals of the first CMR set;
K_{CMR2} is a second number of the second reference signals of the second CMR set;
N is a beam sweeping factor at the UE; and
T_{RS} is a periodicity for the periodic transmissions of the first reference signals and the second reference signals.

10. The method of claim 8, wherein a first number of the first reference signals of the first CMR set is different than a second number of the second reference signals in the second CMR set.

11. The method of claim 8, further comprising performing layer 3 (L3) measurement with respect to the first reference signals and the second reference signals to identify the plurality of broader beams.

12. The method of claim 8, wherein a number of the plurality of narrow beams that is in each of the plurality of broader beams is less than or equal to a beam sweeping factor for the first reference signals and the second reference signals that is used at the UE.

13. The method of claim 8, wherein the first reference signals and the second reference signals comprise a plurality of synchronization signal blocks (SSBs).

14. The method of claim 8, wherein the first reference signals and the second reference signals comprise a plurality of channel state information reference signals (CSI-RSs).

15. A method of a radio access network (RAN), comprising:
sending, to a user equipment (UE) having a first antenna panel and a second antenna panel, a first channel measurement resource (CMR) set identifying first reference signals transmitted by a first TRP of the network and a second CMR set identifying second reference signals transmitted by a second TRP of the network, wherein the first reference signals and the second reference signals are together transmitted periodically;
sending, to the UE, one of:
a first indication that the UE is to use only one of the first antenna panel and the second antenna panel at a time for measurements of the first reference signals and the second reference signals during each periodic transmission of the first reference signals and the second reference signals; and
a second indication that the UE is to simultaneously use the first antenna panel and the second antenna panel for measurements of the first reference signals and the second reference signals during periodic transmissions of the first reference signals and the second reference signals; and
receiving, from the UE, a beam report indicating a first selected reference signal of the first reference signals and a second selected reference signal of second reference signals.

16. The method of claim 15, wherein a first number of the first reference signals of the first CMR set is different than a second number of the second reference signals in the second CMR set.

17. The method of claim 15, wherein the first reference signals and the second reference signals comprise a plurality of synchronization signal blocks (SSBs).

18. The method of claim 15, wherein the first reference signals and the second reference signals comprise a plurality of channel state information reference signals (CSI-RSs).

19. The method of claim 15, wherein the one of the first indication and the second indication is sent to the UE in one of radio resource control (RRC) signaling, a medium access control control element (MAC-CE), and downlink control information (DCI).

20-24. (canceled)
